(19) United States
(12) Patent Application Publication
(10) Pub. No.: US 2026/0037077 A1
(43) Pub. Date: Feb. 5, 2026

(54) XR CONTROLLER

(71) Applicant: Wacom Co., Ltd., Saitama (JP)

(72) Inventor: Kiyokazu SAKAI, Saitama (JP)

(73) Assignee: Wacom Co., Ltd., Saitama (JP)

(21) Appl. No.: 19/359,409

(22) Filed: Oct. 15, 2025

Related U.S. Application Data
(63) Continuation of application No. PCT/JP2023/043616, filed on Dec. 6, 2023.

(30) Foreign Application Priority Data
Apr. 18, 2023 (JP) 2023-067725
Nov. 17, 2023 (JP) 2023-196243

(51) Int. Cl. G06F 3/0346; G06F 3/01; G06F 3/03

(52) U.S. Cl. CPC G06F 3/0346; G06F 3/011; G06F 3/0304

(57) ABSTRACT

Disclosed herein is an XR controller including a casing and first markers arranged in a phyllotaxis arrangement on a surface of the casing.

### BACKGROUND

### Technical Field

The present disclosure relates to a controller compatible with extended reality (XR) (hereinafter, referred to as an XR controller) used in a space configured by an XR technology such as virtual reality (VR), augmented reality (AR), mixed reality (MR), or substitutional reality (SR) (hereinafter, referred to as an “XR space”).

### Description of the Related Art

There is known a system in which a position and a posture of an XR controller are detected by disposing a plurality of markers as trackers on a surface of the XR controller and shooting these markers by using one or more cameras to execute tracking. An example of this kind of system is disclosed in PCT Patent Publication No. WO2022/201693. This document discloses an example of a disposition method for markers on a surface of a casing of an XR controller with a shape made by attaching a grip to a pen.

To allow detection of the position and the posture of the XR controller with high accuracy, at least three markers are required to be disposed in video shot by a camera, in a state in which the markers are sufficiently separate from one another, and disposition patterns of these three markers are required to be sufficiently different from one another (not to be similar) depending on the shooting direction.

### BRIEF SUMMARY

Therefore, one of objects of the present disclosure is to provide an XR controller configured to allow detection of the position and the posture thereof with high accuracy.

An XR controller according to the present disclosure is an XR controller including a casing and first markers arranged in a phyllotaxis arrangement on a surface of the casing.

According to the present disclosure, it becomes possible to detect the position and the posture of the XR controller with high accuracy.

### BRIEF DESCRIPTION OF THE SEVERAL VIEWS OF THE DRAWINGS

FIG. 1 is a diagram depicting a use state of a tracking system according to a first embodiment of the present disclosure;

FIG. 2 is a diagram depicting a state in which a user grasps a controller with a right hand;

FIGS. 3A and 3B are perspective views of the controller as viewed from various angles;

FIGS. 4A and 4B are perspective views of the controller as viewed from various angles;

FIG. 5 is a perspective view of the controller according to the first embodiment of the present disclosure;

FIGS. 6A to 6C are diagrams for explaining a disposition method for a plurality of markers (disposition at a substantially even density);

FIGS. 7A and 7B are diagrams for explaining a disposition method for a plurality of markers (disposition at vertices of a regular polyhedron or a geodesic dome);

FIGS. 8A and 8B are diagrams for explaining the disposition method for a plurality of markers (disposition at vertices of a regular polyhedron or a geodesic dome);

FIGS. 9A and 9B are diagrams for explaining a disposition method for a plurality of markers (disposition with a lattice-shaped pattern);

FIG. 10A is a diagram depicting types of a spiral phyllotaxis, and FIG. 10B is a diagram depicting an example of a ⅜ phyllotaxis;

FIG. 11 is a diagram depicting an example of specific disposition of a plurality of markers in a spiral disposition portion;

FIGS. 12A and 12B are diagrams depicting the example of specific disposition of the plurality of markers in the spiral disposition portion;

FIG. 13 is a perspective view of the controller according to a modification of the first embodiment of the present disclosure;

FIG. 14 is a perspective view of the controller according to a second embodiment of the present disclosure;

FIG. 15A is a diagram depicting an example in which a plurality of markers are disposed on a surface of an ellipsoidal body, and FIG. 15B is a diagram depicting an example in which a plurality of markers are disposed on a surface of a circular column;

FIGS. 16A and 16B are diagrams depicting another example of disposition (double spiral) of a plurality of markers in a spiral disposition portion;

FIGS. 17A and 17B are diagrams depicting another example of the disposition (combination of spirals inverted from each other in a phyllotaxis axis direction) of the plurality of markers in the spiral disposition portion;

FIGS. 18A and 18B are diagrams depicting another example of the disposition (spiral in which an interval in the phyllotaxis axis direction is changed) of the plurality of markers in the spiral disposition portion;

FIG. 19 is a perspective view of the controller according to a first modification of the second embodiment of the present disclosure;

FIG. 20 is a perspective view of the controller according to a second modification of the second embodiment of the present disclosure;

FIG. 21 is a perspective view of the controller according to a third modification of the second embodiment of the present disclosure;

FIG. 22 is a perspective view of the controller according to a fourth modification of the second embodiment of the present disclosure;

FIGS. 23A and 23B are each a diagram depicting a disposition example of markers in a non-spiral disposition portion;

FIG. 24 is a perspective view of the controller according to a fifth modification of the second embodiment of the present disclosure;

FIGS. 25A to 25D are diagrams depicting an example of specific disposition of a plurality of markers in the controller according to the fifth modification of the second embodiment of the present disclosure;

FIGS. 26A to 26D are diagrams depicting the example of specific disposition of the plurality of markers in the controller according to the fifth modification of the second embodiment of the present disclosure; and

FIGS. 27A and 27B are diagrams depicting the example of specific disposition of the plurality of markers in the controller according to the fifth modification of the second embodiment of the present disclosure.

### DETAILED DESCRIPTION

Embodiments of the present disclosure are described in detail below with reference to the accompanying drawings.

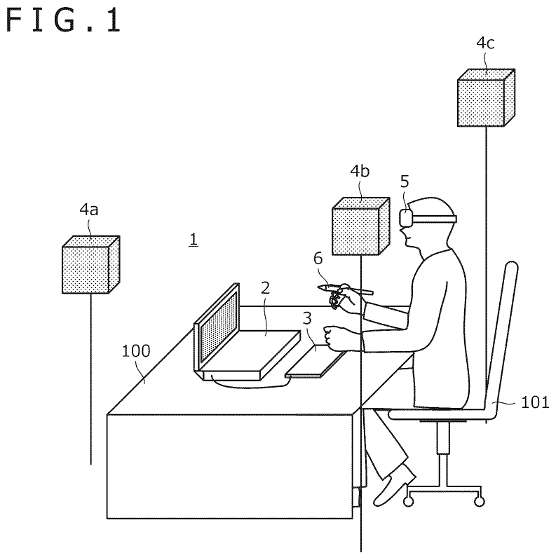

FIG. 1 is a diagram depicting a use state of a tracking system 1 according to a first embodiment of the present disclosure. As depicted in this diagram, the tracking system 1 has a computer 2, a position detection device 3, three cameras 4a to 4c, a head-mounted display 5, and a controller 6 of a pen type. The configuration is made such that the computer 2 can communicate with each of the position detection device 3, the cameras 4a to 4c, the head-mounted display 5, and the controller 6 in a wired or wireless manner.

As depicted in FIG. 1, a user uses the tracking system 1 in a state in which the user sits on a desk chair 101, wears the head-mounted display 5 at the head, and holds the controller 6 with a right hand. An XR space obtained by rendering by the computer 2 is displayed on a display surface of the head-mounted display 5, and the user operates the controller 6 over a desk 100 while viewing this XR space.

The controller 6 is an XR controller employed for use in the XR space and is used for control of a 3D object displayed in the XR space (specifically, rendering of a 3D object, movement of a 3D object, and the like). Further, the controller 6 is formed into a pen-type shape and is used also for making inputs by using the position detection device 3.

In the example of FIG. 1, the computer 2 is configured by a notebook personal computer disposed at a center of the desk 100. However, the computer 2 is not necessarily required to be disposed at the center of the desk 100 and is only required to be disposed at a position at which the computer 2 can communicate with the position detection device 3, the cameras 4a to 4c, the head-mounted display 5, and the controller 6. Moreover, the computer 2 can be configured by various types of computers such as a desktop personal computer, a tablet personal computer, a smartphone, and a server computer besides the notebook personal computer.

The computer 2 plays a role in tracking motion of the head-mounted display 5, the controller 6, and the position detection device 3 by periodically detecting a position and a posture of each of them on the basis of video shot by the cameras 4a to 4c. The computer 2 executes processing of generating an XR space and a 3D object to be displayed therein on the basis of the motion of each device that the computer 2 is tracking and an operation state of each operation button and dial button that are disposed on the controller 6 and are described later, and rendering the generated XR space and 3D object and transmitting them to the head-mounted display 5. The head-mounted display 5 plays a role in displaying the XR space including one or more 3D objects by displaying the rendering image transmitted from the computer 2.

In the example of FIG. 1, the position detection device 3 is configured by a tablet disposed at a position corresponding to a front side of the computer 2 as viewed from the user, in an upper surface of the desk 100. However, the position detection device 3 is not necessarily required to be disposed at this position and is only required to be disposed in a range within a reach of a hand of the user who sits on the desk chair 101. Further, the position detection device 3 and the computer 2 may be configured by an integrated device such as a tablet terminal.

The position detection device 3 has functions of periodically detecting a position of a pen tip of the controller 6 on a touch surface and sequentially transmitting the detected position to the computer 2. The computer 2 executes generation and rendering of stroke data that configures a 2D object or a 3D object, on the basis of the transmitted position. Although the specific system of the position detection by the position detection device 3 is not limited to a particular one, it is preferable to use, for example, an active capacitive system or a capacitive induction system.

The cameras 4a to 4c are each an imaging device for shooting a still image or a moving image and are configured to sequentially supply video obtained by shooting to the computer 2. The camera 4a, the camera 4b, and the camera 4c are disposed at a position opposite to the user across the desk 100, on an upper left side of the user, and on an upper right side of the user, respectively, such that each camera has such an orientation as to be capable of shooting the upper surface of the desk 100. The cameras 4a to 4c are each a camera having a rolling shutter and are disposed such that a sub-scanning direction of the rolling shutter corresponds with a vertical direction in order to minimize distortion of the controller 6 in video.

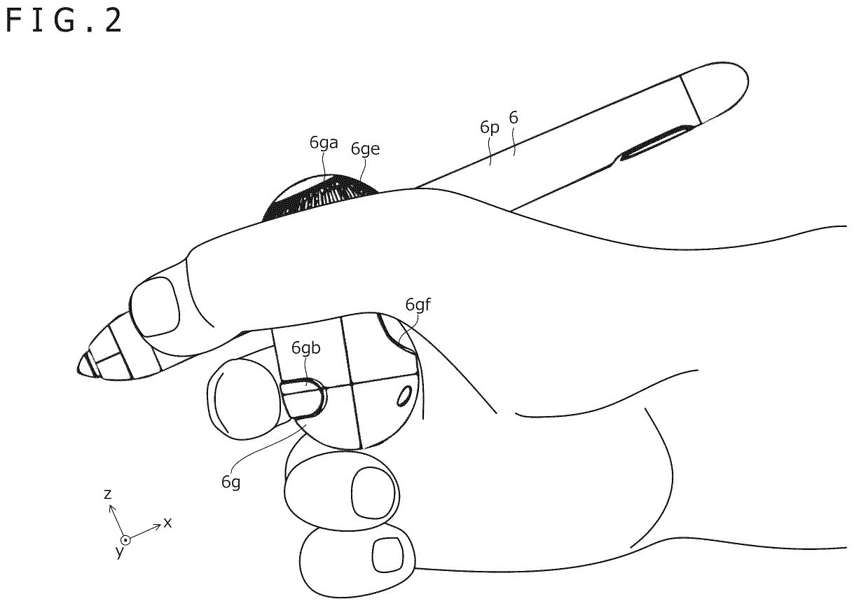

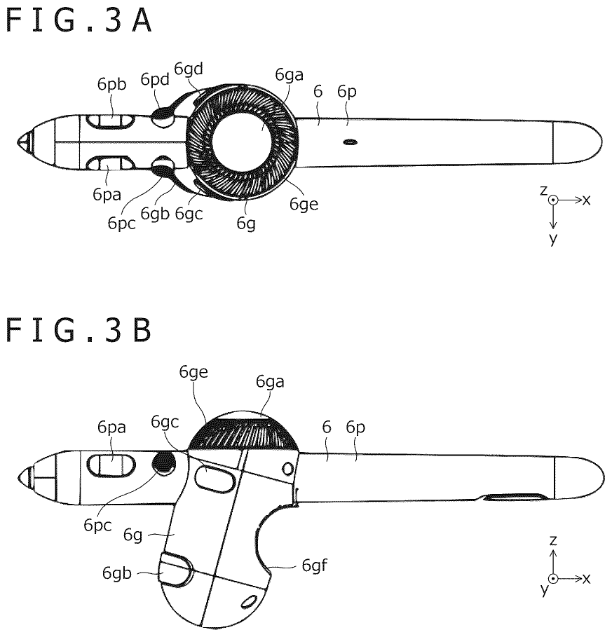

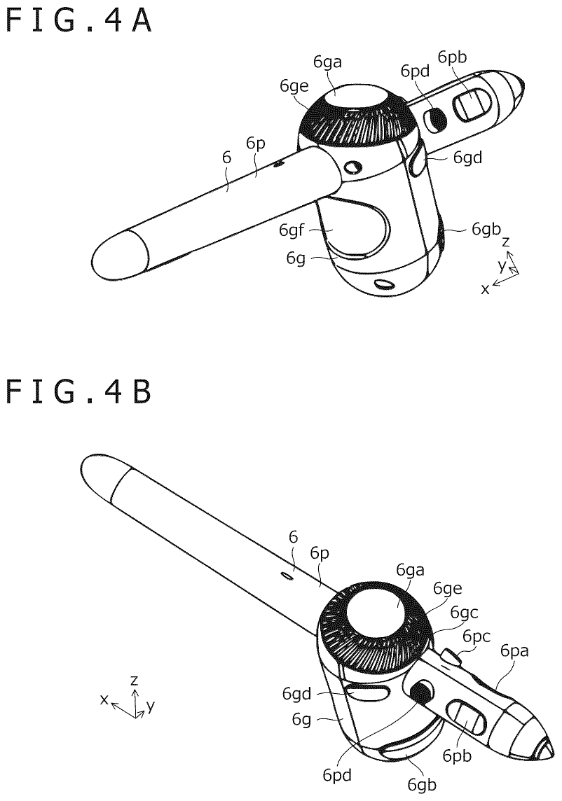

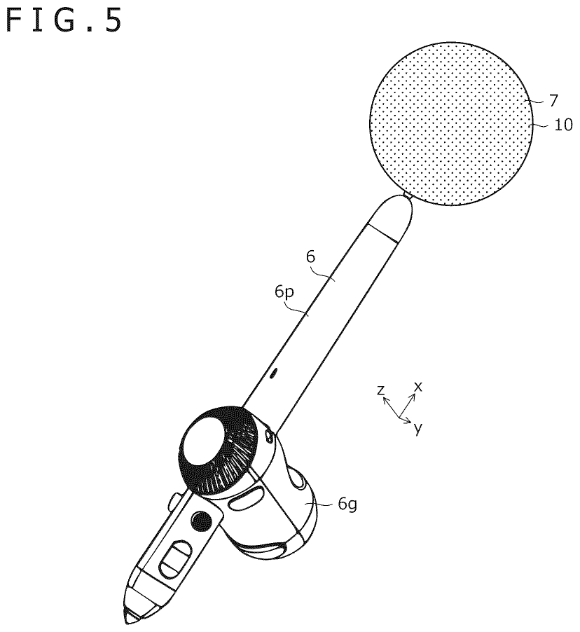

FIG. 2 is a diagram depicting a state in which the user grasps the controller 6 with the right hand. Moreover, FIGS. 3A, 3B, 4A, and 4B are perspective views of the controller 6 as viewed from various angles. Although the actual controller 6 has a spiral disposition portion 10 depicted in FIG. 5 to be given later, drawing thereof is omitted in these diagrams. Details of the spiral disposition portion 10 are described later with reference to FIGS. 5 to 12B.

As depicted in FIGS. 2, 3A, 3B, 4A, and 4B, the controller 6 has a pen portion 6p formed into a pen shape and a grip portion 6g fixed to the pen portion 6p with a longitudinal direction thereof intersecting an axial direction of the pen portion 6p. Hereinafter, the axial direction of the pen portion 6p is referred to as an x-direction. A direction that is a direction in a plane configured by the x-direction and the longitudinal direction of the grip portion 6g and is orthogonal to the x-direction is referred to as a z-direction. A direction orthogonal to each of the x-direction and the z-direction is referred to as a y-direction.

As depicted in FIG. 3A, pressure pads 6pa and 6pb and shift buttons 6pc and 6pd are disposed on a surface of the pen portion 6p. The pressure pads 6pa and 6pb are each a component including a pressure sensor and a touch sensor and are disposed at positions near the pen tip in a side surface of the pen portion 6p symmetrically with respect to an xz-plane. Pressure detected by the pressure sensor is used for selection or rendering on an application. Meanwhile, information indicating whether or not a touch detected by the touch sensor is present is used for implementing on/off-determination of pressure sensor output and a light double tap. Each of the shift buttons 6pc and 6pd is a switch assigned to a menu of an application and are disposed at positions between the pressure pads 6pa and 6pb and the grip portion 6g symmetrically with respect to the xz-plane. As is understood from FIG. 2, the user who grasps the controller 6 with the right hand executes operation of the pressure pad 6pa and the shift button 6pc with the thumb and executes operation of the pressure pad 6pb and the shift button 6pd with the index finger.

A tact top button 6ga, a grab button 6gb, tact buttons 6gc and 6gd, a dial button 6ge, and a recessed portion 6gf are disposed on a surface of the grip portion 6g as depicted in FIGS. 3A, 3B, 4A, and 4B. The tact top button 6ga is a switch that functions as a power button through long-pressing, and is disposed on the surface of an end portion closer to the pen portion 6p out of both end portions of the grip portion 6g in the longitudinal direction. Hereinafter, this end portion is referred to as an “upper end portion,” and an end portion remoter from the pen portion 6p out of both end portions of the grip portion 6g in the longitudinal direction is referred to as a “lower end portion.” The dial button 6ge is a ring-shaped component configured to be rotatable, and is configured to output a rotation amount. For example, this rotation amount is used to rotate an object currently selected. The dial button 6ge is also disposed at the upper end portion of the grip portion 6g in such a manner as to surround the tact top button 6ga.

The grab button 6gb is a switch used to grab and move an object and is disposed at a position near the lower end portion in a side surface of the grip portion 6g on the pen tip side. Further, the tact buttons 6gc and 6gd are each a switch used for button assistance like a right button of a mouse and are disposed at positions near the pen portion 6p as viewed in the z-direction in the side surface of the grip portion 6g on the pen tip side. The tact button 6gc is disposed on the thumb side when the controller 6 is grasped with the right hand. The tact button 6gd is disposed on the index finger side when the controller 6 is grasped with the right hand.

As is understood from FIG. 2, the user who grasps the controller 6 with the right hand executes pressing-down operation of the grab button 6gb with the middle finger. Moreover, the user executes pressing-down operation of the tact button 6gc with the thumb and executes pressing-down operation of the tact button 6gd with the index finger. Rotational operation of the dial button 6ge and pressing-down operation of the tact top button 6ga are executed with the thumb of the user. However, the tact top button 6ga and the dial button 6ge exist at positions at which they are impossible to operate unless the user intentionally raises the thumb to the upper end portion of the grip portion 6g, and thus are exposed without being hidden by the hand of the user in a normal state.

As depicted in FIG. 2, the recessed portion 6gf is a portion configured to allow a portion ranging from the root of the index finger to the root of the thumb to be just fitted into it when the user grasps the controller 6. Making this recessed portion 6gf in the controller 6 alleviates fatigue of the user who uses the controller 6.

Next, a detailed description is given of the spiral disposition portion 10 disposed for the controller 6 to allow the computer 2 to detect the position and the posture of the controller 6 with high accuracy.

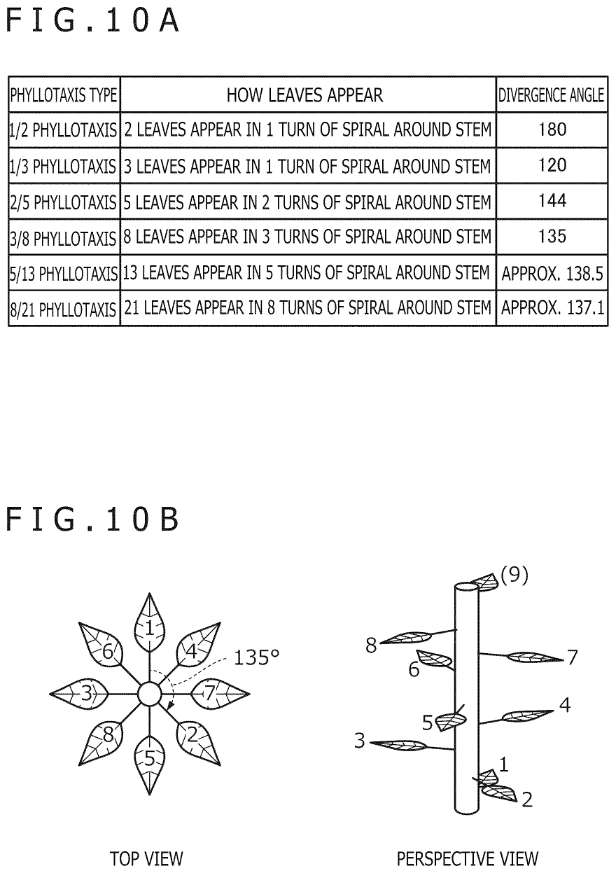

FIG. 5 is a perspective view of the controller 6 according to the present embodiment. As depicted in this diagram, the controller 6 includes a spherical portion 7 attached to a tail end of the pen portion 6p. The spherical portion 7 forms a casing of the controller 6 together with the pen portion 6p and the grip portion 6g. A plurality of markers are arranged in a phyllotaxis arrangement on a surface of the spherical portion 7, and the spiral disposition portion 10 is configured by these plurality of markers. The phyllotaxis arrangement is described in detail later with reference to FIGS. 10A to 12B.

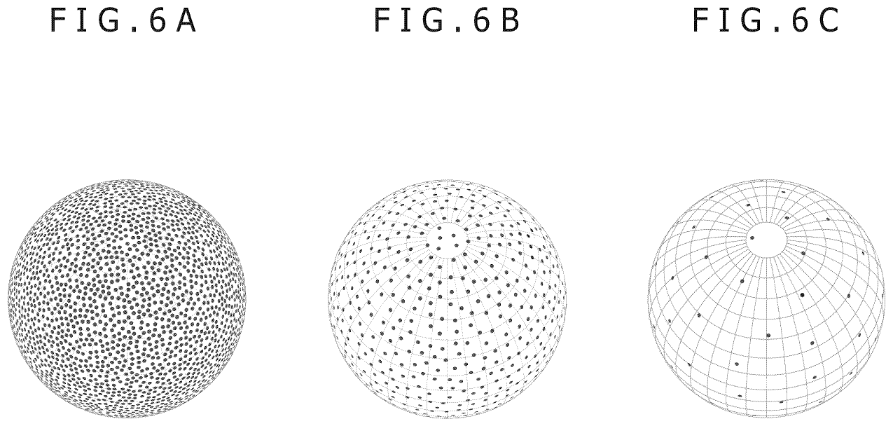

Although the specific kind of markers configuring the spiral disposition portion 10 is not limited to a particular one, it is preferable to employ infrared light emitting diodes (LEDs). In this case, the cameras 4a to 4c are each configured by an infrared camera that can visualize infrared, and the computer 2 is configured to detect the position and the posture of the controller 6 on the basis of the disposition of the markers that appear in video shot by the cameras 4a to 4c. The disposition of the plurality of markers in the spiral disposition portion 10 is specifically described below with reference to FIGS. 6A to 12B.

First, FIGS. 6A to 9B are diagrams for explaining disposition methods for the plurality of markers. In the following, after various disposition methods are described with reference to FIGS. 6A to 9B, a detailed description is given of a detailed configuration of the spiral disposition portion 10 according to the present embodiment and an advantage of employment of the spiral disposition portion 10 according to the present embodiment with reference to FIGS. 10A to 12B.

FIGS. 6A to 6C are diagrams depicting examples in which a plurality of markers are disposed at a substantially even density. In FIGS. 6A to 6C, a spherical shape represents the spherical portion 7, and black circles represent individual markers. Hereinafter, disposition based on these examples is referred to as “substantially-even density disposition.” FIGS. 6A to 6C depict an example in which the plurality of markers are disposed with the substantially-even density disposition at a high density, an example in which the plurality of markers are disposed with the substantially-even density disposition at a density of a middle degree, and an example in which the plurality of markers are disposed with the substantially-even density disposition at a low density, respectively. As a method for deciding the specific position of each marker in the substantially-even density disposition, there is a method in which a plurality of disposition patterns are generated in a random number manner by a sequential random method, a Poisson-disk sampling method, or the like and the most preferred disposition among them is decided by using a measure such as the Monte Carlo method.

To allow the computer 2 to detect the position and the posture of the controller 6 with high accuracy, a plurality of markers are required to be disposed on a surface of the casing such that at least three markers appear in video shot by each of the cameras 4a to 4c in a state in which the markers are sufficiently separate from one another (that is, without disposition unevenness) and disposition patterns (geometric characteristics) thereof are sufficiently different from one another (that is, are not similar) depending on the shooting direction. Hereinafter, this disposition is referred to as “preferred disposition.” In a case of using the substantially-even density disposition depicted in FIGS. 6A to 6C, it is possible to implement the preferred disposition if the number of markers is sufficiently large. However, in view of a size of the individual infrared LEDs and a size of the spherical portion 7, there is a limit on the number of markers that can be disposed on the surface of the spherical portion 7. Thus, it is not practical to implement the preferred disposition by the substantially-even density disposition.

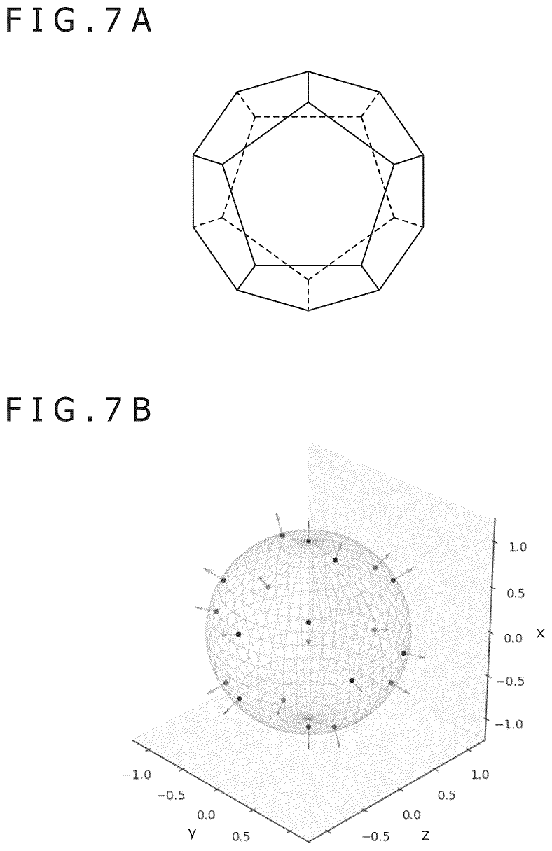

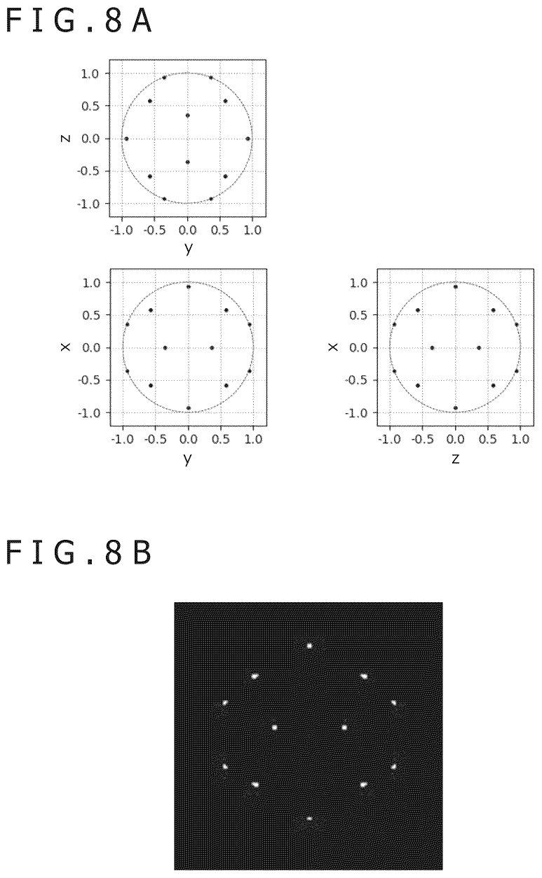

FIGS. 7A to 8B are diagrams depicting an example in which markers are disposed at vertices of a regular polyhedron (regular dodecahedron, regular icosahedron, or the like) or a geodesic dome (solid obtained by segmentalizing faces of a regular polyhedron or a semiregular polyhedron to increase the number of vertices). Hereinafter, disposition based on this example is referred to as “polyhedron-derivative disposition.”

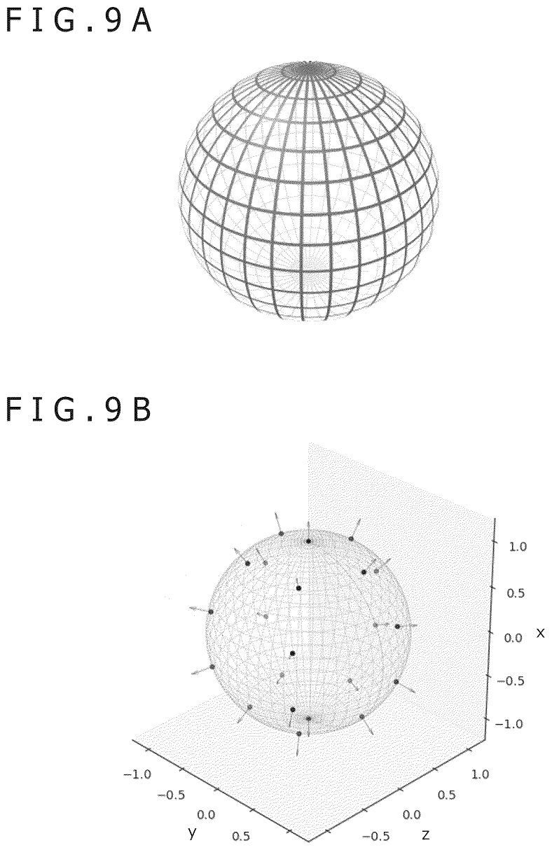

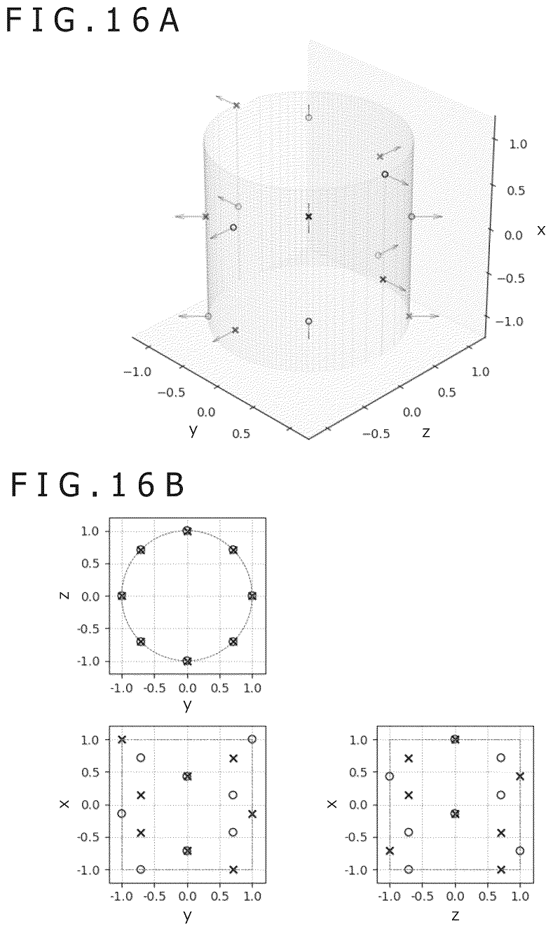

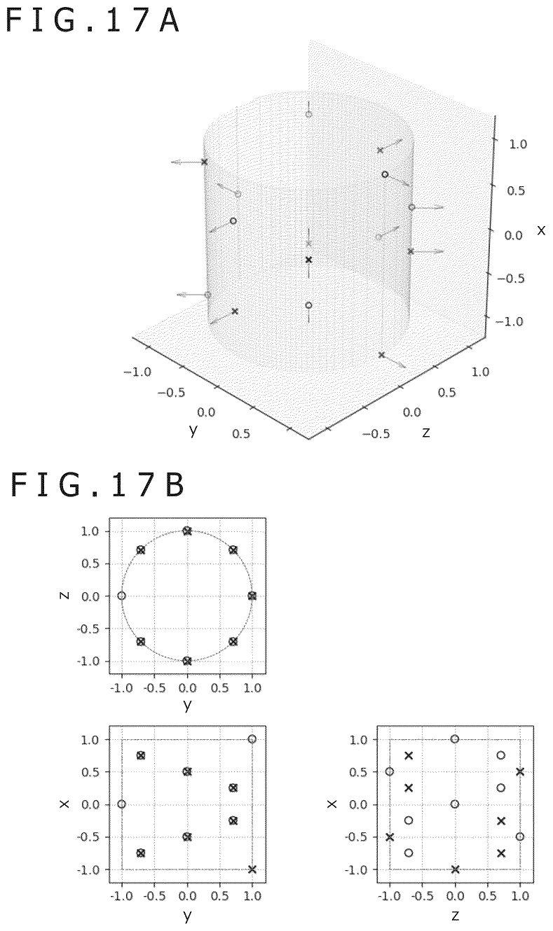

FIG. 7A depicts an example of a regular dodecahedron. FIG. 7B depicts an example in which a marker is disposed at a position corresponding to each of 20 vertices that the regular dodecahedron has in the surface of a sphere. In FIG. 7B, a spherical shape represents the spherical portion 7, and black circles represent the individual markers. In addition, an arrow extending from each black circle represents a normal direction to the spherical surface (curved surface) at the position of this black circle. This point is the same also in FIGS. 9B, 11, 15A, 15B, 16A, 17A, and 18A to be described later. However, in FIGS. 16A and 17A, white circles and cross marks are used instead of the black circles for convenience of drawing.

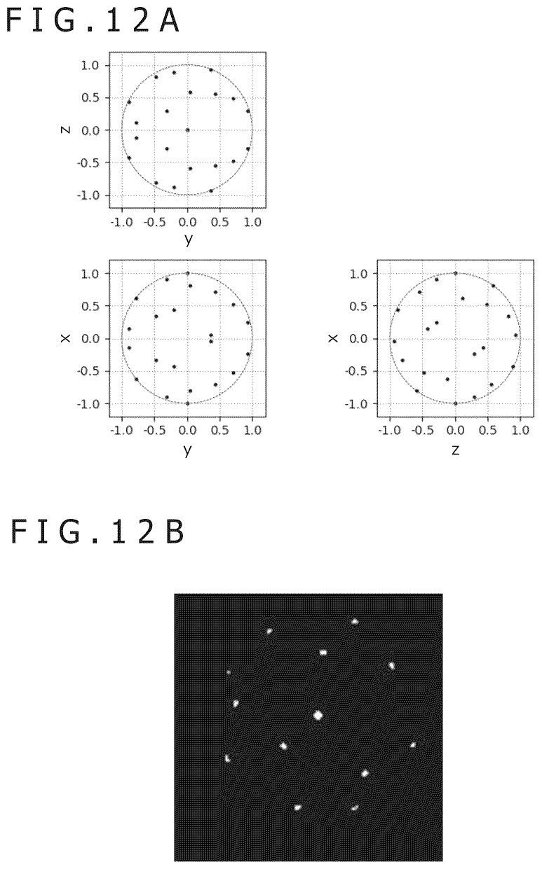

FIG. 8A depicts projections of the spherical portion 7 having 20 markers disposed at the 20 vertices that the regular dodecahedron has in the x-direction (upper left), the z-direction (lower left), and the y-direction (lower right). FIG. 8B depicts an image obtained when the spherical portion 7 of FIG. 8A is shot by the camera 4a. Here, each diagram of FIG. 8A is a transparent diagram. Thus, not only markers located on a front side as viewed from the user's point of view but also markers located on a back side are plotted. This point is the same also in FIGS. 12A, 16B, 17B, and 18B to be given later. However, in FIG. 8A, the disposition of the markers on the front side corresponds with the disposition of the markers on the back side. Thus, as a result, the same picture as a picture in a case in which only the markers disposed on the front side are drawn is depicted.

As is understood from FIGS. 7A to 8B, in a case of using the polyhedron-derivative disposition, it is possible to implement appearance of at least three markers in video shot by each of the cameras 4a to 4c, in the state in which the markers are sufficiently separate from one another (that is, without disposition unevenness). Meanwhile, the polyhedron-derivative disposition involves a problem that it is impossible to implement such disposition that disposition patterns (geometric characteristics) of the markers are sufficiently different from one another (that is, are not similar) depending on the shooting direction. Hereinafter, this problem is referred to as an “aperture problem.”

The reason why the aperture problem occurs in the polyhedron-derivative disposition is because the symmetry of the disposition is too high. A description is given with a specific example. Among the three projections depicted in FIG. 8A, the projection in the z-direction (lower left) is exactly the same as the projection in the y-direction (lower right). Further, the projection in the x-direction (upper left) is also the same as the projection in the z-direction (lower left) and the projection in the y-direction (lower right) except that the projection is rotated by 90°. That is, the disposition patterns (geometric characteristics) of the markers are not sufficiently different from one another depending on the shooting direction. As a result, it is impossible to identify the direction in which the image depicted in FIG. 8B is shot. Therefore, it can be said that it is difficult to implement the preferred disposition by the polyhedron-derivative disposition.

FIGS. 9A and 9B are diagrams depicting an example in which a plurality of markers are disposed with a pattern of a lattice manner (square lattice, hexagonal lattice, rectangular lattice, rhombic lattice, or the like). Hereinafter, disposition based on this example is referred to as “planar-lattice-derivative disposition.” FIG. 9A depicts an example of a square lattice drawn on a spherical surface. FIG. 9B depicts an example in which the markers are disposed at some of intersections of the square lattice depicted in FIG. 9A (that is, intersections of line segments that equally divide the latitude and the longitude).

When the planar-lattice-derivative disposition is used, it is possible to implement appearance of at least three markers in video shot by each of the cameras 4a to 4c, in the state in which the markers are sufficiently separate from one another (that is, without disposition unevenness). However, also in the planar-lattice-derivative disposition, the aperture problem occurs as with the polyhedron-derivative disposition. Therefore, it can be said that, also with the planar-lattice-derivative disposition, implementing the preferred disposition is difficult.

With the spiral disposition portion 10 according to the present embodiment, it becomes possible to overcome the above-described drawbacks of the substantially-even density disposition, the polyhedron-derivative disposition, and the planar-lattice-derivative disposition and dispose a plurality of markers on the surface of the casing such that at least three markers appear in video shot by each of the cameras 4a to 4c, in the state in which the markers are sufficiently separate from one another (that is, without disposition unevenness), and disposition patterns (geometric characteristics) thereof are sufficiently different from one another (that is, are not similar) depending on the shooting direction. A detailed description is given below with reference to FIGS. 10A to 12B.

First, a general description of the phyllotaxis arrangement is given. The phyllotaxis refers to a pattern when leaves of a plant in nature are arranged with respect to a stem. The phyllotaxis includes “alternate phyllotaxis,” in which one leaf appears at one node of the stem, “opposite phyllotaxis,” in which two leaves appear at one node of the stem, and “whorled phyllotaxis,” in which three or more leaves appear at one node of the stem. In the alternate phyllotaxis, a phyllotaxis in which leaves appear in a manner of a spiral extending along an extension direction of the stem is particularly referred to also as “spiral phyllotaxis.”

FIG. 10A is a diagram depicting types of the spiral phyllotaxis. As depicted in this diagram, the spiral phyllotaxis includes various types classified depending on how leaves appear, and each type is referred to as r/n phyllotaxis. The r/n phyllotaxis is such a way of appearance of leaves that the leaf that appears from a stem at the same angle (angle as viewed from directly above) as the first leaf next to the first leaf is the (n+1)th leaf and the spiral makes r turns around the stem in a section from the first leaf to the (n+1)th leaf. As depicted in FIG. 10A, various combinations between r and n, such as ½ phyllotaxis, ⅓ phyllotaxis, ⅖ phyllotaxis, ⅜ phyllotaxis, 5/13 phyllotaxis, and 8/21 phyllotaxis, possibly exist.

It is known that r and n of the r/n phyllotaxis satisfy a relation of r/n=Fₖ/(mFₖ+Fₖ₋₁) (Schimper-Braun's law). Fₖ is the kth term of the Fibonacci sequence, and m is a natural number. In many cases, m=2 is satisfied. In this case, r and n are composed of a Fibonacci number (1, 1, 2, 3, 5, 8 . . . ) and a Fibonacci number (2, 3, 5, 8, 13, 21 . . . ) subsequent thereto by two numbers.

FIG. 10B is a diagram depicting an example of the ⅜ phyllotaxis (r=3, n=8). “135 degrees” indicated in this diagram is a projection angle (angle as viewed in an axial direction of the spiral) between the nth leaf and the (n+1)th leaf and is referred to as a “divergence angle.” As indicated in FIG. 10A, the divergence angle differs depending on the type of the phyllotaxis. Specifically, the divergence angle is as follows: 180 degrees in the ½ phyllotaxis, 120 degrees in the ⅓ phyllotaxis, 144 degrees in the ⅖ phyllotaxis, 135 degrees in the ⅜ phyllotaxis, 1800/13≈138.5 degrees in the 5/13 phyllotaxis, and 2880/21≈137.1 degrees in the 8/21 phyllotaxis.

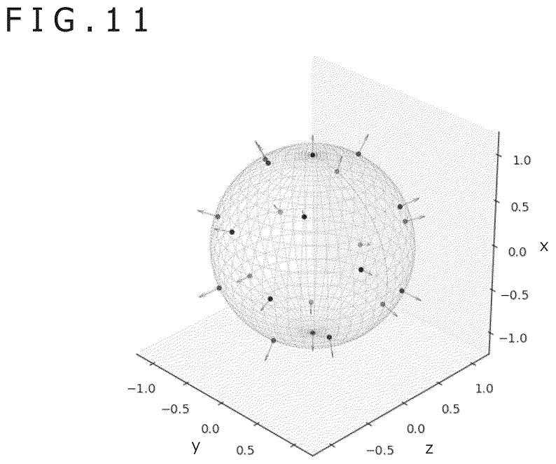

FIGS. 11, 12A, and 12B are diagrams depicting an example of specific disposition of a plurality of markers (plurality of markers arranged in a phyllotaxis arrangement) in the spiral disposition portion 10. FIG. 11 depicts an example in which 22 markers are disposed with the 8/21 phyllotaxis on a surface of a sphere. As depicted in this diagram, the plurality of markers configuring the spiral disposition portion 10 are disposed such that an axis of the phyllotaxis arrangement (line corresponding to the stem, hereinafter referred to as a “phyllotaxis axis”) passes through a center of the spherical body forming the spherical portion 7. It is sufficient that an interval between the markers in the phyllotaxis axis direction is set to an equal pitch. Although the example in which the pen axis (=x-axis) corresponds with the phyllotaxis axis is depicted in FIG. 11, they are not necessarily required to correspond with each other. FIG. 12A depicts projections of the spherical portion 7 having the plurality of markers based on the example of FIG. 11 in the x-direction (upper left), the z-direction (lower left), and the y-direction (lower right). FIG. 12B depicts an image obtained when the spherical portion 7 of FIG. 12A is shot by the camera 4a.

As is understood from FIGS. 11, 12A, and 12B, in a case of using the phyllotaxis arrangement, it is possible to implement appearance of at least three markers in video shot by each of the cameras 4a to 4c, in the state in which the markers are sufficiently separate from one another (that is, without disposition unevenness). In addition, when the phyllotaxis arrangement is used, the markers can be disposed such that disposition patterns (geometric characteristics) of the markers are sufficiently different from one another (that is, are not similar) depending on the shooting direction. Thus, the occurrence of the aperture problem can be avoided. Looking at the image of FIG. 12B, it is understood that this image is neither the lower left image (projection in the z-direction) of FIG. 12A nor the lower right image (projection in the y-direction) but corresponds to the upper left image (projection in the x-direction). This represents an aspect of the fact that the aperture problem does not occur when the phyllotaxis arrangement is used. Therefore, it can be said that the preferred disposition can be implemented by the phyllotaxis arrangement.

As described above, with the configuration of the controller 6 according to the present embodiment, it becomes possible to dispose a plurality of markers on the surface of the casing such that at least three markers appear in video shot by each of the cameras 4a to 4c, in the state in which the markers are sufficiently separate from one another (that is, without disposition unevenness), and disposition patterns (geometric characteristics) thereof are sufficiently different from one another (that is, are not similar) depending on the shooting direction. Therefore, it becomes possible to detect the position and the posture of the controller 6 with high accuracy by using the plurality of markers disposed on the surface of the casing.

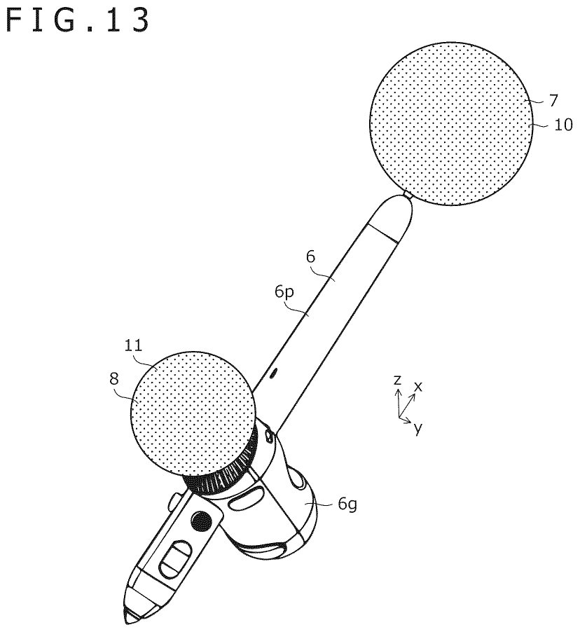

FIG. 13 is a perspective view of the controller 6 according to a modification of the present embodiment. The controller 6 according to the present modification further includes a spherical portion 8 attached to the upper end portion of the grip portion 6g in the controller 6 according to the present embodiment. The spherical portion 8 forms the casing of the controller 6 together with the pen portion 6p, the grip portion 6g, and the spherical portion 7. A plurality of markers (infrared LEDs) are arranged in a phyllotaxis arrangement on a surface of the spherical portion 8 as with the surface of the spherical portion 7, and a spiral disposition portion 11 is configured by these plurality of markers. The computer 2 is configured to detect the position and the posture of the controller 6 on the basis of the disposition of the markers of each of the spiral disposition portions 10 and 11 that appear in video shot by the cameras 4a to 4c. This allows the computer 2 to detect the posture of the controller 6 also from a relative positional relation between the spiral disposition portions 10 and 11. Thus, it becomes possible to detect the position and the posture of the controller 6 with higher accuracy.

The spiral disposition portions 10 and 11 are not required to have exactly the same shape. For example, sizes of the spherical portions 7 and 8 may be different from each other, or the spiral disposition portions 10 and 11 may employ different types of phyllotaxis. This can avoid detection with confusion between the spiral disposition portions 10 and 11 by the computer 2.

Next, the tracking system 1 according to a second embodiment of the present disclosure is described. The tracking system 1 according to the present embodiment is different from the tracking system 1 according to the first embodiment in the configuration of the controller 6. Thus, in the following, the same reference symbols as those in the first embodiment are given and description is omitted concerning points similar to those of the tracking system 1 according to the first embodiment, and the description is continued with focus on different points from the first embodiment.

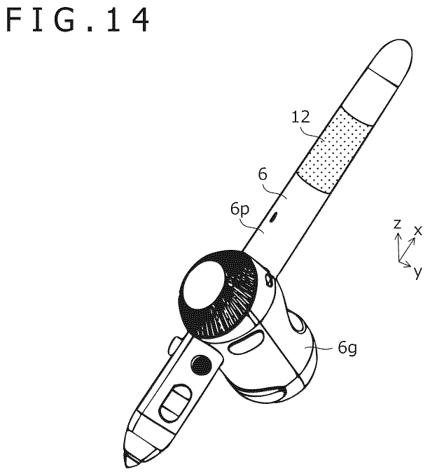

FIG. 14 is a perspective view of the controller 6 according to the present embodiment. As depicted in this diagram, the controller 6 according to the present embodiment has a spiral disposition portion 12 not in the spherical portion 7 (see FIG. 5) but in the side surface of the pen portion 6p. The spherical portion 7 is not provided in the controller 6 according to the present embodiment.

A configuration of the spiral disposition portion 12 is specifically described. First, the spiral disposition portion 12 is disposed in the side surface of the pen portion 6p on the tail end side relative to the grip portion 6g. Further, although not clearly depicted in FIG. 14, the spiral disposition portion 12 has a plurality of markers arranged in a phyllotaxis arrangement such that the phyllotaxis axis corresponds with the pen axis. It is preferable that the kind of markers be an infrared LED as with the first embodiment.

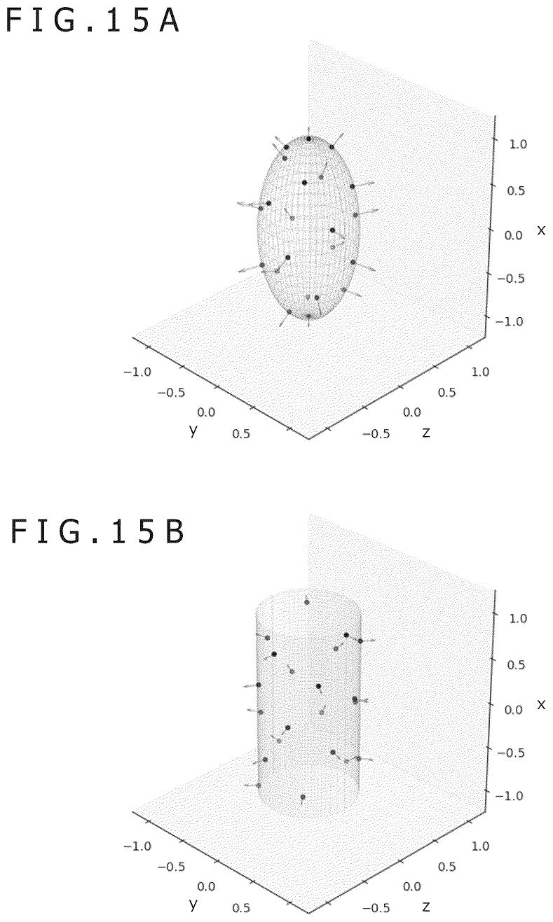

FIG. 15A is a diagram depicting an example in which a plurality of markers are disposed on a surface of an ellipsoidal body. FIG. 15B is a diagram depicting an example in which a plurality of markers are disposed on a surface of a circular column. Both are examples in which 22 markers are disposed with the 8/21 phyllotaxis. The plurality of markers are arranged in a phyllotaxis arrangement in each example such that the phyllotaxis axis corresponds with a major axis of the ellipsoidal body in the former example and the phyllotaxis axis corresponds with a circular column axis in the latter example. It is sufficient that an interval between the markers in the phyllotaxis axis direction is set to an equal pitch as with the case of disposition on the surface of the sphere. As depicted in these examples, not only the surface of the sphere described in the first embodiment but also surfaces with various shapes can be used as the curved surface on which the plurality of markers are arranged in the phyllotaxis arrangement. The spiral disposition portion 12 according to the present embodiment is made by disposing the plurality of markers on the side surface of the pen portion 6p with use of such nature of the phyllotaxis arrangement.

Also by the configuration of the controller 6 according to the present embodiment, it becomes possible to dispose a plurality of markers on the surface of the casing such that at least three markers appear in video shot by each of the cameras 4a to 4c, in the state in which the markers are sufficiently separate from one another (that is, without disposition unevenness), and disposition patterns (geometric characteristics) thereof are sufficiently different from one another (that is, are not similar) depending on the shooting direction. Therefore, it becomes possible to detect the position and the posture of the controller 6 with high accuracy by the plurality of markers disposed on the surface of the casing.

Here, the disposition of the plurality of markers in the spiral disposition portion 12 is not limited to a simple phyllotaxis arrangement like those depicted in FIGS. 15A and 15B. This point is described in detail below with reference to FIGS. 16A to 18B.

FIGS. 16A and 16B, FIGS. 17A and 17B, and FIGS. 18A and 18B are diagrams depicting other different examples of the disposition of the plurality of markers in the spiral disposition portion 12. FIGS. 16A, 17A, and 18A are transparent perspective views of the spiral disposition portion 12. FIGS. 16B, 17B, and 18B are diagrams depicting projections in the x-direction (upper left), the z-direction (lower left), and the y-direction (lower right) concerning the spiral disposition portion 12 depicted in FIG. 16A, 17A, or 18A.

FIGS. 16A and 16B depict an example in which the spiral disposition portion 12 is configured by two spirals each composed of a plurality of markers arranged in a phyllotaxis arrangement with the ⅜ phyllotaxis. In this diagram, white circles indicate one spiral, and cross marks indicate the other spiral. In this example, the other spiral arises from rotating the one spiral around the phyllotaxis axis (around the x-axis) by 180°, and a double spiral is formed by the two spirals. The spiral disposition portion 12 according to the present embodiment can be configured also by such a double spiral. Employing this configuration can further reduce a risk of the occurrence of the aperture problem. Although the example of the double spiral is depicted in FIGS. 16A and 16B, it is also possible to configure the spiral disposition portion 12 by a triple or more multiple spiral.

FIGS. 17A and 17B also depict an example in which the spiral disposition portion 12 is configured by two spirals each composed of a plurality of markers arranged in a phyllotaxis arrangement with the ⅜ phyllotaxis. Also in this diagram, white circles indicate one spiral, and cross marks indicate the other spiral. In this example, the other spiral arises from inverting the one spiral in the phyllotaxis axis direction (x-direction). It is also possible to configure the spiral disposition portion 12 according to the present embodiment by combining the spirals inverted from each other in the phyllotaxis axis direction in this manner. Employing this configuration can further reduce the risk of the occurrence of the aperture problem.

In the example of FIGS. 17A and 17B, the number of markers per one turn of the spiral is seven, and the number of markers when the spirals inverted in the phyllotaxis axis direction (x-direction) are combined is 13 (reason why the number is not 7×2=14 is because two markers among them exist at the same position). Therefore, it can be said that, according to the example of FIGS. 17A and 17B, compared with the case of disposing a plurality of markers with the 5/13 phyllotaxis with the same pitch in the phyllotaxis axis direction as that in each spiral, the number of markers comparable to that in that case can be implemented in a small range in the phyllotaxis axis direction.

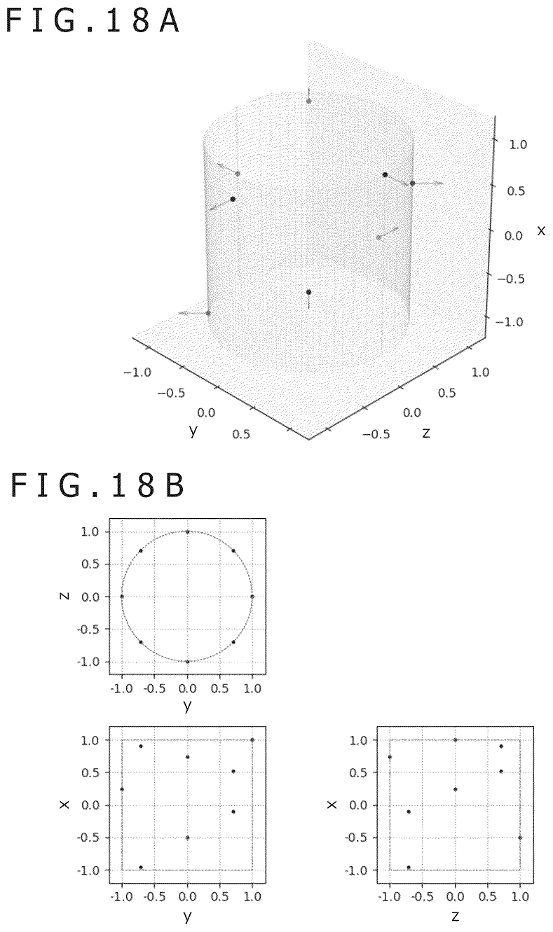

FIGS. 18A and 18B depicts an example in which the spiral disposition portion 12 is configured by one spiral composed of a plurality of markers arranged in a phyllotaxis arrangement with the ⅜ phyllotaxis. In this example, the interval between adjacent two markers in the phyllotaxis axis direction (x-direction) is increased in arithmetic progression. It is also possible to configure the spiral disposition portion 12 according to the present embodiment by a modified phyllotaxis arrangement formed by changing the interval in the phyllotaxis axis direction in this manner. Employing this configuration can further reduce the risk of the occurrence of the aperture problem. Although the example in which the interval between adjacent two markers in the phyllotaxis axis direction is increased in arithmetic progression is depicted in FIGS. 18A and 18B, the interval between adjacent two markers in the phyllotaxis axis direction may be changed by another method. In an example, the interval may be increased in geometric progression.

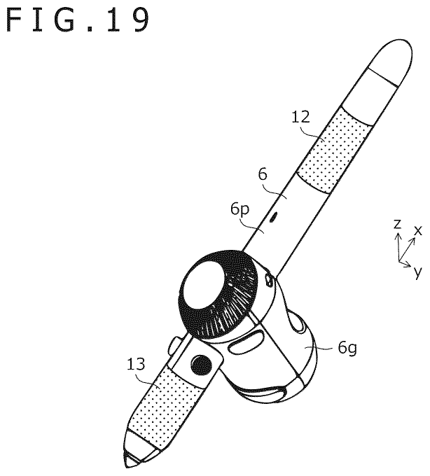

Next, the controllers 6 according to first to fourth modifications of the present embodiment are described with reference to FIGS. 19 to 23B.

FIG. 19 is a perspective view of the controller 6 according to the first modification of the present embodiment. The controller 6 according to the present modification further has a spiral disposition portion 13 disposed in the side surface of the pen portion 6p on the pen tip side relative to the grip portion 6g in the controller 6 according to the present embodiment. The spiral disposition portion 13 has a plurality of markers arranged in a phyllotaxis arrangement such that the phyllotaxis axis corresponds with the pen axis as with the spiral disposition portion 12. Specific disposition of the plurality of markers in the spiral disposition portion 13 may be similar to that in the spiral disposition portion 12 or may be different. For example, a plurality of markers may be disposed with a simple phyllotaxis arrangement in the spiral disposition portion 12, whereas a plurality of markers may be disposed with a phyllotaxis arrangement with the irregular spiral structure described with reference to FIGS. 16A to 18B in the spiral disposition portion 13. When the spiral disposition portions 12 and 13 employ different types of disposition, the computer 2 is allowed to easily discriminate and detect the spiral disposition portions 12 and 13 on the basis of the disposition of the markers of each of the spiral disposition portions 12 and 13 that appear in video shot by the cameras 4a to 4c. Moreover, it also becomes possible to reduce the risk of the occurrence of the aperture problem compared with the case of using the spiral disposition portion 12 alone.

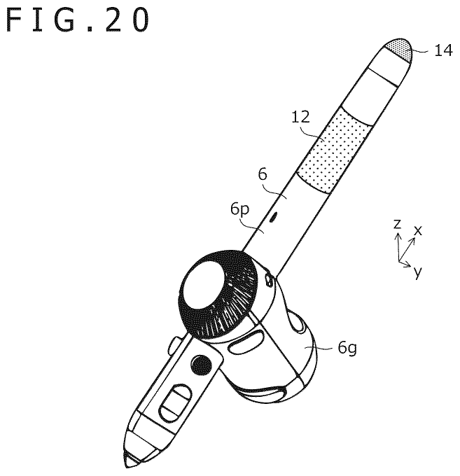

FIG. 20 is a perspective view of the controller 6 according to the second modification of the present embodiment. The controller 6 according to the present modification further has a non-spiral disposition portion 14 disposed at the tail end of the pen portion 6p in the controller 6 according to the present embodiment. The non-spiral disposition portion 14 has one or more markers disposed independently of the phyllotaxis arrangement. The risk of the occurrence of the aperture problem can be reduced by using such a non-spiral disposition portion 14 in combination with the spiral disposition portion 12. Thus, the computer 2 is allowed to detect the position and the posture of the controller 6 with high accuracy compared with the case of using the spiral disposition portion 12 alone.

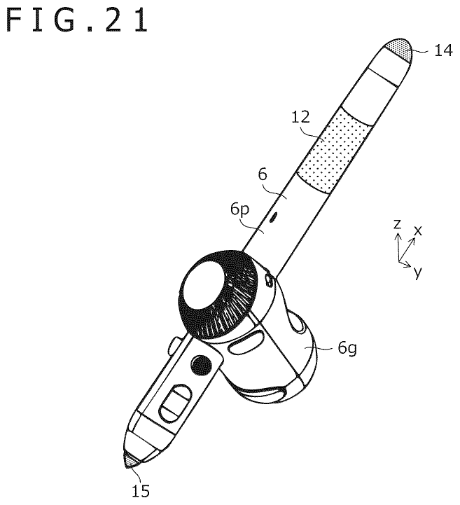

FIG. 21 is a perspective view of the controller 6 according to the third modification of the present embodiment. The controller 6 according to the present modification further has a non-spiral disposition portion 15 disposed at the pen tip in the controller 6 according to the third modification of the present embodiment. The non-spiral disposition portion 15 has one or more markers disposed independently of the phyllotaxis arrangement, as with the non-spiral disposition portion 14. The risk of the occurrence of the aperture problem can further be reduced by using not only the non-spiral disposition portion 14 but also the non-spiral disposition portion 15 in combination with the spiral disposition portion 12. Thus, the computer 2 is allowed to detect the position and the posture of the controller 6 with high accuracy compared with the case of using the non-spiral disposition portion 14 and the spiral disposition portion 12 in combination.

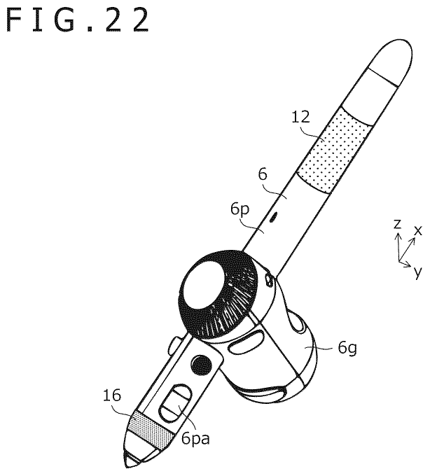

FIG. 22 is a perspective view of the controller 6 according to the fourth modification of the present embodiment. The controller 6 according to the present modification further has a non-spiral disposition portion 16 disposed in the side surface of the pen portion 6p on the pen tip side relative to the grip portion 6g in the controller 6 according to the present embodiment. In the first modification, the description has been given of the example in which the spiral disposition portion 13 is disposed in the side surface of the pen portion 6p on the pen tip side relative to the grip portion 6g. However, a wide space is required for disposing the spiral disposition portion 13. Thus, as depicted in FIG. 19, the installation space for the pressure pads 6pa and 6pb is invaded by the spiral disposition portion 13 in the first modification. The non-spiral disposition portion 16 can be installed without a wide space like that for the spiral disposition portion 13. Thus, it becomes possible to avoid such invasion and install the pressure pads 6pa and 6pb.

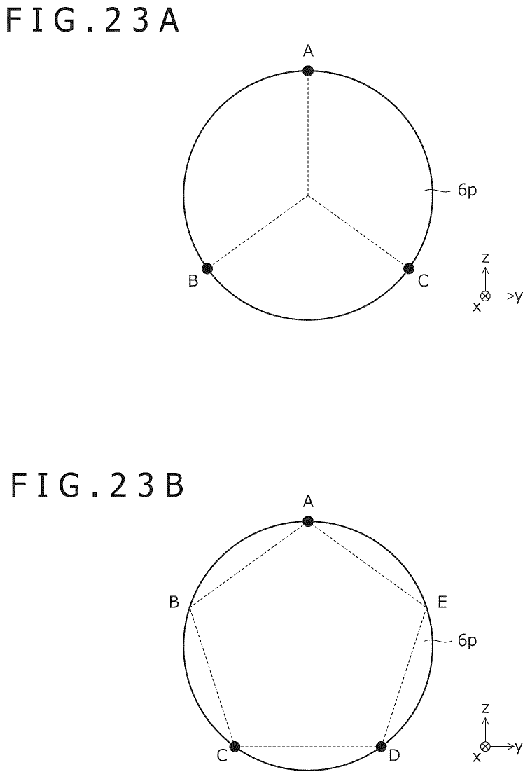

FIGS. 23A and 23B are each a diagram depicting a disposition example of markers in the non-spiral disposition portion 16. In the example of FIG. 23A, a marker (black circle) is disposed at each of three vertices of an equilateral triangle disposed in a circular yz-section of the pen portion 6p (section perpendicular to the pen axis). This disposition can reduce the possibility of the occurrence of the aperture problem compared with the case of using only the spiral disposition portion 12. Further, in the example of FIG. 23B, markers (black circles) are disposed at three of five vertices of a regular pentagon (vertices A, C, and D in a case in which the respective vertices are referred to as A to E in a counterclockwise direction) disposed in a circular yz-section of the pen portion 6p (section perpendicular to the pen axis). This disposition makes it possible to reduce the possibility of the occurrence of the aperture problem even when the spiral disposition portion 12 is not shot and only the non-spiral disposition portion 16 is shot.

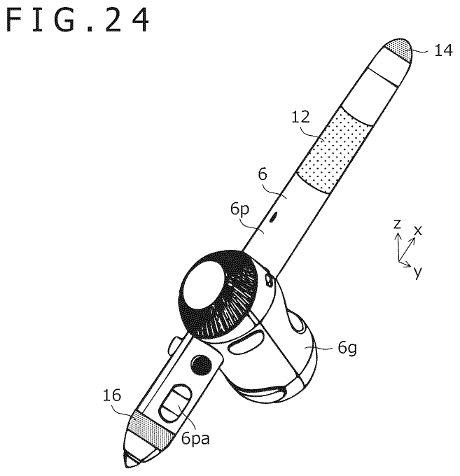

FIG. 24 is a perspective view of the controller 6 according to a fifth modification of the present embodiment. The controller 6 according to the present modification can further reduce the risk of the occurrence of the aperture problem by using also the non-spiral disposition portion 14 in addition to the spiral disposition portion 12 and the non-spiral disposition portion 16 in the controller 6 according to the fourth modification of the present embodiment. Thus, the computer 2 is allowed to detect the position and the posture of the controller 6 with high accuracy compared with the case of using only the spiral disposition portion 12 and the non-spiral disposition portion 16.

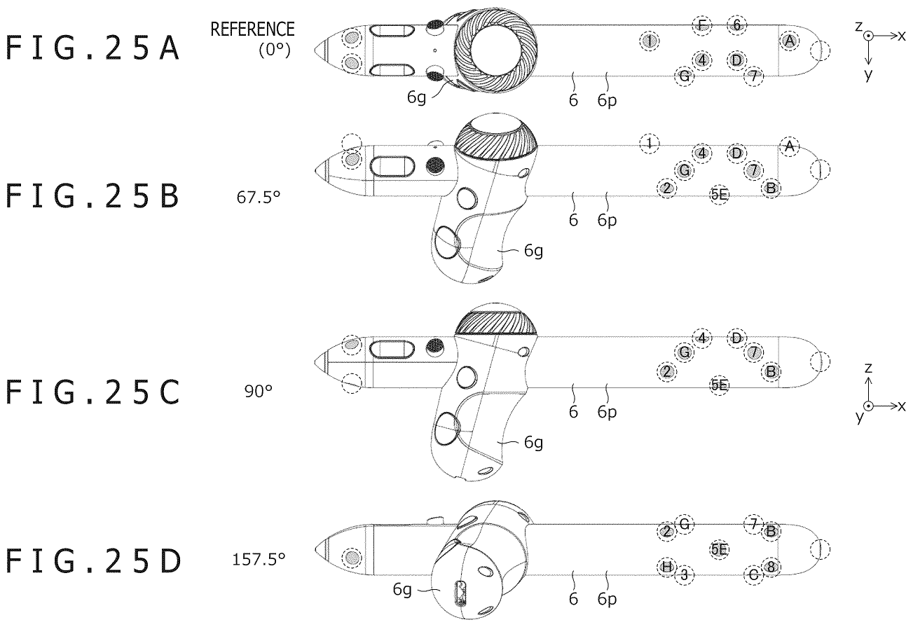

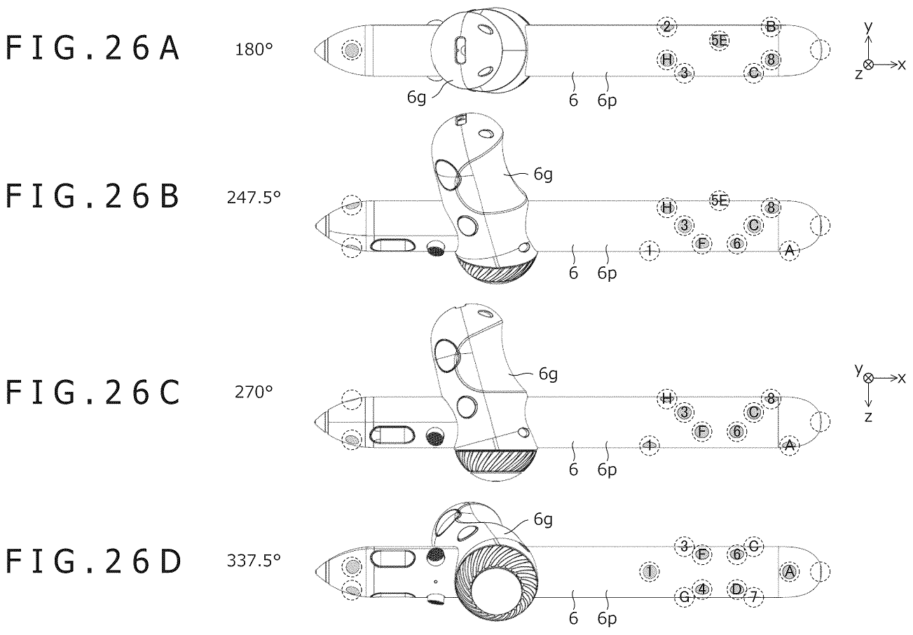

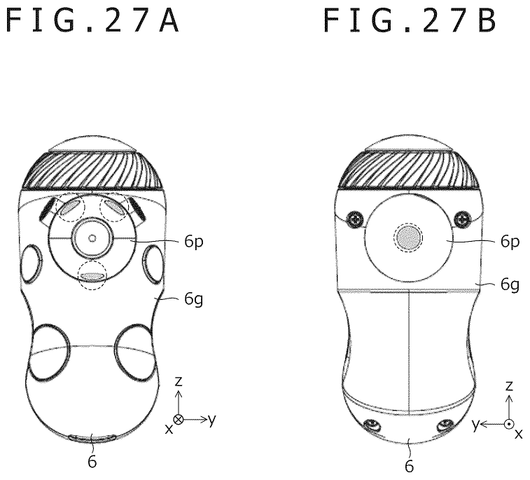

FIGS. 25A to 27B are diagrams depicting an example of specific disposition of a plurality of markers in the controller 6 according to the fifth modification of the present embodiment. FIGS. 25A to 25D and FIGS. 26A to 26D each depict the side surface of the controller 6 obtained when the point of view is rotated around the x-direction (axial direction of the pen portion 6p) by an angle indicated in the diagram. Moreover, FIG. 27A depicts the side surface of the controller 6 as viewed from the pen tip. FIG. 27B depicts the side surface of the controller 6 as viewed from the tail end of the pen. FIGS. 25A to 27B depict an example in which the spiral disposition portion 12 is configured by the disposition of the plurality of markers depicted in FIGS. 17A and 17B and the non-spiral disposition portion 16 is configured by the disposition of the plurality of markers depicted in FIG. 23B.

In FIGS. 25A to 27B, dashed circles are given at the positions at which the markers exist, in order to make the position of each marker clear. Further, concerning the spiral disposition portion 12, serial numbers 1 to 8 of eight markers forming one spiral are indicated in the dashed circles, and serial letters A to H of eight markers forming the other spiral are indicated in the dashed circles. As is understood from the indication of these serial numbers and letters, in the example depicted in FIGS. 25A to 27B, the disposition of the plurality of markers depicted in FIGS. 17A and 17B (disposition based on one spiral composed of eight markers arranged in a phyllotaxis arrangement with the ⅜ phyllotaxis and the other spiral arising from inverting this one spiral in the phyllotaxis axis direction (x-direction)) is implemented.

Although advantageous embodiments of the present disclosure have been described above, it is obvious that the present disclosure is not limited to such embodiments at all and can be carried out in various modes without departing from the gist thereof.

For example, the phyllotaxis arrangement with the irregular spiral structure described with reference to FIGS. 16A to 18B (double spiral or multiple spiral, combination of spirals inverted from each other in the phyllotaxis axis direction, or spiral in which the interval in the phyllotaxis axis direction is changed) may be applied to the spiral disposition portion 10 or 11 described in the first embodiment.

Moreover, one controller 6 may be formed by combining, as appropriate, the spiral disposition portions 10 and 11 described in the first embodiment and the spiral disposition portions 12 and 13 and the non-spiral disposition portions 14 to 16 described in the second embodiment. As an example, the controller 6 depicted in FIG. 13 may be combined with the spiral disposition portions 12 and 13 and the non-spiral disposition portion 15, or may be combined with the spiral disposition portion 12 and the non-spiral disposition portions 15 and 16. Further, one controller 6 may be formed by selecting, as appropriate, some of the spiral disposition portions 10 and 11 described in the first embodiment and the spiral disposition portions 12 and 13 and the non-spiral disposition portions 14 to 16 described in the second embodiment. For example, it is also possible to form the controller 6 that does not have the spiral disposition portion 10 but have the spiral disposition portion 11 and does not have the spiral disposition portion 12 but have the spiral disposition portion 13 and the non-spiral disposition portions 14 to 16.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An extended reality controller comprising:
a casing; and
a plurality of first markers arranged in a first phyllotaxis arrangement on a surface of the casing.

2. The extended reality controller according to claim 1, wherein:
the casing includes a pen portion formed into a pen shape, and
the plurality of first markers is disposed on a surface of the pen portion.

3. The extended reality controller according to claim 2, further comprising:
a plurality of second markers different from the first markers, wherein
the plurality of second markers is arranged in a second phyllotaxis arrangement at a position in the surface of the casing on a pen tip side relative to the plurality of first markers.

4. The extended reality controller according to claim 1, wherein
the first phyllotaxis arrangement is a phyllotaxis arrangement with a double spiral structure.

5. The extended reality controller according to claim 1, wherein:
the first phyllotaxis arrangement is a phyllotaxis arrangement with a combination of spirals inverted from each other in a phyllotaxis axis direction.

6. The extended reality controller according to claim 1, wherein:
the first phyllotaxis arrangement is a phyllotaxis arrangement with a spiral in which an interval in a phyllotaxis axis direction is changed.

7. The extended reality controller according to claim 1, wherein:
the casing includes a spherical portion formed into a shape of a spherical body, and
the plurality of first markers is disposed such that a phyllotaxis axis passes through a center of the spherical body forming the spherical portion.

8. The extended reality controller according to claim 7, wherein:
the casing further includes a pen portion formed into a pen shape, and
the spherical portion is attached to a tail end of the pen portion.

9. The extended reality controller according to claim 1, further comprising:
a plurality of second markers arranged in a second phyllotaxis arrangement on the surface of the casing, wherein:
the casing includes a first spherical portion and a second spherical portion each formed into a shape of a spherical body,
the plurality of first markers is disposed such that a phyllotaxis axis of the first phyllotaxis arrangement passes through a center of the spherical body forming the first spherical portion, and
the plurality of second markers is disposed such that a phyllotaxis axis of the second phyllotaxis arrangement passes through a center of the spherical body forming the second spherical portion.

10. The extended reality controller according to claim 9, wherein:
the casing further includes:
a pen portion formed into a pen shape, and
a grip portion fixed to the pen portion such that a longitudinal direction of the grip portion intersects an axial direction of the pen portion,
the first spherical portion is disposed at a tail end of the pen portion, and
the second spherical portion is disposed at an end portion closer to the pen portion out of both end portions of the grip portion in the longitudinal direction.
